(19) United States
(12) Patent Application Publication
(10) Pub. No.: US 2007/0067282 A1
(43) Pub. Date: Mar. 22, 2007

(54) Domain-based spam-resistant ranking

(75) Inventors: Amit Prakash, Bellevue, WA (US); Michael J. Narayan, Seattle, WA (US); Darren A. Shakib, North Bend, WA (US); Marc A. Najork, Palo Alto, CA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/230,784

(22) Filed: Sep. 20, 2005

(51) Int. Cl. G06F 17/30

(52) U.S. Cl. 707/5

(57) ABSTRACT

A domain-based spam-resistant ranking architecture that computes trust in a domain based on web-servers on which a domain is hosted and a set of other domains that link to the domain. The ranks of pages are computed based on how much trust there is in each domain and which pages link to it. Web documents are ranked in a spam-resistant manner by assigning uniform significance to each IP address of a network location and then assigning trust values to domains hosted on those IP addresses. Then, based on a domain graph, the invention constructs a domain-rank which is an estimate of how authoritative the domain is. The domain ranks are then used to assign a minimum rank to each document.

### BACKGROUND

With the enormous amounts of information available in the Internet, searching for the desired information is fraught with pitfalls and unwanted information. Search algorithms come in a variety of types, but principally provide some sort of ranking algorithm that ranks the search results for the user. One conventional ranking algorithm, standard PageRank™, gives substantial endorsement power to hosts/domains/servers that contain many web pages. In U.S. Patent Application Publication 2005/0060297 entitled “Systems and Methods for ranking Documents based upon Structurally Interrelated Information”, a link-spam resistant version of PageRank gives the same power to each server. Thus, the standard PageRank algorithm favors web servers with large numbers of documents by giving the servers more “voting power”.

A web search service accepts a user query and returns a list of documents that satisfy the query. In order to provide a satisfactory experience to the user, this list of results should be ordered, with the documents that are most relevant to the user appearing first. There exists a multitude of algorithms for ranking documents; most web search engines employ several such algorithms, and rank the results of a query based on a combination of the ranks assigned by the different ranking algorithms.

Ranking algorithms can be classified as query-dependent (also called dynamic) or query-independent (also called static). Query-dependent ranking algorithms use the terms in the query and query-independent algorithms do not. That is, query-independent ranking algorithms assign a quality score to each document on the web. Consequently, query-independent ranking algorithms can be run ahead of time and do not need to be rerun whenever a query is submitted.

Ranking algorithms can also be broadly classified into content-based, usage-based, and link-based ranking algorithms. Content-based ranking algorithms use the words in a document to rank the document among other documents. For example, a query-dependent content-based ranking algorithm could give higher scores to documents that contain the query terms early on in the document or in a large or boldfaced font. Usage-based ranking algorithms rank web pages based on an estimate of how often they are viewed. Such estimates can be produced by examining web proxy logs or by monitoring click-through on the search engine's results pages. Finally, link-based ranking algorithms use the hyperlinks between web pages to rank web pages. For example, a very naive static link-based ranking algorithm could assign a score to each web page that is proportional to the number of links pointing to the page (the idea being that the links pointing to a page “endorse” the page).

PageRank™ is a well-known query-independent link-based ranking algorithm. Assume that the set of known web pages and links between them induces a graph with vertex set V (where each vertex corresponds to a web page) and edge set E (where each edge (u,v) corresponds to a hyperlink from page u to page v). Let O(u) denote the out-degree of vertex u (that is, the number of hyperlinks embedded in web page u), and let d be a number between 0 and 1 (say, 0.15). The PageRank R(v) of a web page v can be defined to be:

$$R ( v ) = \frac{d}{\vert V \vert} + ( 1 - d ) {\sum }_{( u , v ) ∈ E} \frac{R ( u )}{O ( u )}$$

The PageRank formula is often explained as follows. Consider a web surfer who is performing a random walk on the web. At every step along the walk, the surfer moves from one web page to another, using the following algorithm. With some probability d, the surfer selects a web page uniformly at random and jumps to it; otherwise, the surfer selects one of the outgoing hyperlinks in the current page uniformly at random and follows it. Because of this metaphor, the number d is sometimes called the “jump probability”—the probability that the surfer will jump to a completely random page. If the web surfer jumps with probability d and there are |V| web pages, the probability to jump to a particular page is dl|V|. Since any page can be reached by jumping, every page is guaranteed a score of at least dl|V|.

PageRank scores can be used to rank query results. A search engine employing PageRank will rank pages with high PageRank scores higher than those with low scores (everything else being the same). Since most users of search engines examine only the first few results, operators of commercial web sites have a vested interest that links to their sites appear early in the result listing, that is, that their web pages receive high PageRank scores. In other words, commercial web site operators have an incentive to artificially increase the PageRank scores of the pages on their web sites.

One way to increase the PageRank score of a web page v is by having many other pages link to it. This is inherent in the basic idea of web pages being able to endorse other web pages, which is at the heart of PageRank. If all of the pages that link to web page v have low PageRank scores, each individual page will contribute only very little. However, since every page is guaranteed to have a minimum PageRank score of dl|V|, links from many such low quality pages can still contribute a sizable total.

In practice, this vulnerability of PageRank is being exploited by web sites that contain a very large set of pages whose only purpose is to “endorse” a main home page. This “home” page does not have to be on the same server, but can be a home page (or any page) of some other server. Typically, these endorsing pages contain a link to the page that is to be endorsed, and another link to another endorsing page. All the endorsing pages are created on the fly. A web crawler, once it has stumbled across any of the endorsing pages, continues to download more endorsing pages (because of the fact that endorsing pages link to other endorsing pages), thereby accumulating a large number of endorsing pages. This large number of endorsing pages, all of them endorsing a single page, artificially inflates the PageRank score of the page that is being endorsed.

This problem was addressed and partially solved by United States patent application publication 2005/0060297 entitled “Systems and Methods for ranking Documents based upon Structurally Interrelated Information” by an inventor of this application. The patent addresses the vulnerability of PageRank to web pages that are artificially generated for the sole purpose of inflating the PageRank score of other pages.

The basic idea is to give each web server, not each web page, a guaranteed minimum score, and divide this rank up among all the pages on a web server. Thus, a page on a web server with many pages is less likely to be reached via a random jump, which implies that the ability of such a page to endorse another page by linking to it is diminished. This solution, although it solves the stated problem, generates new problems.

Again, this approach penalizes pages on web servers with large numbers of documents and rewards pages on web servers with small numbers of documents. The several large domains that host authoritative documents include pages that are unfairly penalized by this algorithm. On the other hand there are several web servers created by individuals that contain less than one hundred documents which are of interest to a very small number of people. This algorithm unfairly rewards these documents as well.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed architecture computes a domain trust value in a domain based on the web servers on which the domain is hosted. Then, it computes a domain rank value based on the domain's trust value and the rank values of other domains linking to the domain. Next, it computes a document trust value based on the domain rank value of the domain containing the document and the number of documents contained in the domain. Finally, the rank of each document is computed based on the trust value of the document and the rank values of other documents linking to the document. Thus, authoritative domains are no longer unfairly penalized and irrelevant domains unfairly favored, as in the prior art.

In another aspect of the subject invention, web documents are ranked in a spam-resistant manner by assigning uniform significance to each IP address of a network location and then assigning trust values to domains hosted on those IP addresses. Based on a domain graph, the innovation facilitates construction of a domain rank value which is an estimate of how authoritative the domain is. The domain ranks are then used to assign a trust value, and thereby a minimum rank to each document. Thus, in order to inflate ranks of a document as a work-around, the author would need to invest money in IP addresses and domains.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a system that facilitates ranking data in accordance with a disclosed innovative aspect.

FIG. 2 illustrates a methodology of ranking data according to an aspect.

FIG. 3 illustrates a methodology of ranking data based on each domain hosted on a web site in accordance with an aspect.

FIG. 4 illustrates a methodology of ranking data based on the number of servers used to host a domain in accordance with an aspect.

FIG. 5 illustrates a methodology of generating a domain-level link graph according to an aspect.

FIG. 6 illustrates a diagram that relates a unidirectional link between documents of two different domains in accordance with the disclosed innovation.

FIG. 7 illustrates a diagram that represents domains, hyperlinks and implied domain links in accordance with the disclosed innovation.

FIG. 8 illustrates a single server and multiple domain representation and associated document links between the different domains in accordance with the disclosed innovation.

FIG. 9 illustrates a single domain and multiple servers of that domain and associated document links in accordance with the disclosed innovation.

FIG. 10 illustrates documents of a single server/multiple domains linking with documents of a single domain/multiple servers in accordance with the disclosed innovation.

FIG. 11 illustrates a block diagram of a computer operable to execute the disclosed architecture.

FIG. 12 illustrates a schematic block diagram of an exemplary computing environment.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

The subject innovation addresses the vulnerability of PageRank to web pages that are artificially generated for the sole purpose of inflating the PageRank score of other pages. This invention achieves this without unfairly penalizing large authoritative domains or unfairly favoring small irrelevant domains.

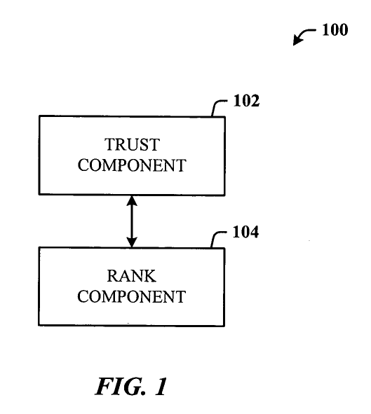

Referring initially to the drawings, FIG. 1 illustrates a system 100 that facilitates ranking data in accordance with a disclosed innovative aspect. The invention ranks web documents in a spam-resistant manner by assigning uniform significance to each IP address and then assigning trust values to domains hosted on those IP addresses. Then based on a domain graph, the invention constructs a domain-rank which is an estimate of how authoritative the domain is. These domain ranks are then used to assign a trust value, and thereby a minimum rank to each document. Thus in order to inflate ranks of a document, the author needs to invest money in IP addresses and domains.

Put another way, initially, a minimum endorsement power (domain trust value) is computed for each domain based on the servers (IP addresses) that are hosting the domain, and the number of other domains hosted along with it. Next, the authority (domain rank) of each domain is computed using, for example, a power iteration method. A minimum rank (document trust value) is then assigned to each document based on the authority of the domain hosting it, and the number of documents hosted on that domain. Finally, a rank for each document is computed using, for example, the power iteration method.

In support thereof, the system 100 includes a trust component 102 that computes a domain trust value for a domain having a document and a rank component 104 that computes a domain rank value for the domain (and document or web page) based on the trust value of the domain as well as domain rank values of other domains that link to the domain. The trust component 102 computes the document trust value based also upon the domain rank value of the domain having the document and the number of document contained in the domain. The rank component 104 can also compute the document rank value of each document or web page and the document rank values of other documents (e.g., none, one or many) that link to that document. The rank component 104 also facilitates presentation of the document or web page according to the document rank value.

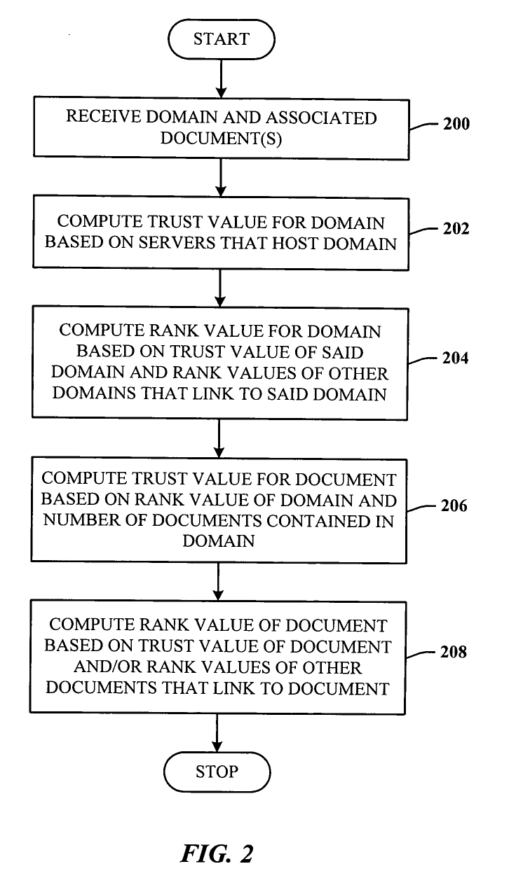

FIG. 2 illustrates a methodology of ranking data according to an aspect. While, for purposes of simplicity of explanation, the one or more methodologies shown herein, e.g., in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

The domain-rank architecture computes the ranks of documents based on the trust placed in documents and the domains containing them, and the links between documents and between domains. Accordingly, a methodology is provided such that, at 200, a domain is received that includes one or more documents. At 202, the domain trust value of a domain is computed based on the web-servers on which the domain is hosted. At 204, the domain rank value of the domain is computed based on the domain trust value and other domain rank values computed for a set of other domains that link to the domain. At 206, a document trust value of a document is computed based on the domain rank value of the domain containing the document and the number of other documents contained in the domain. At 208, a document rank value of a document or web page is computed based on the document trust value (or trust) of the document and/or the document rank values of the other pages or documents that link to the document.

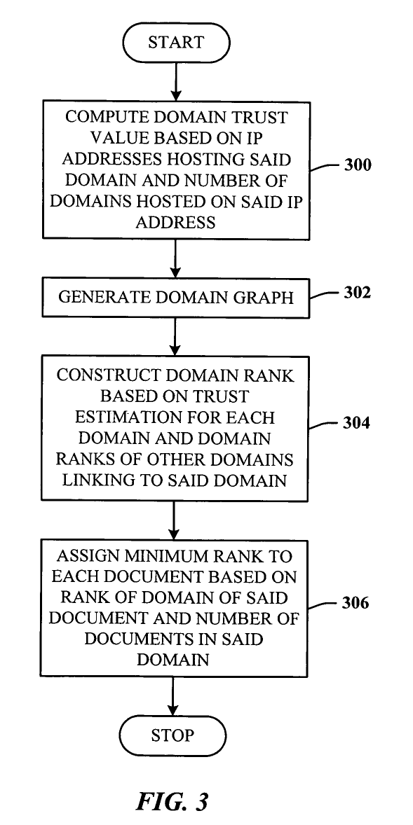

Referring now to FIG. 3, there is illustrated a methodology of ranking data based on each domain hosted on a web site in accordance with an aspect. Problems in the art are solved by estimating the significance of each domain and then assigning the minimum rank to each document of the domain. A novelty is in the hierarchical trust propagation. A domain can have many IP addresses associated with it. At 300, a domain trust value is computed for each domain based on the number of IP addresses hosting that domain, and the number of domains hosted on each said IP address. At 302, a domain graph is generated. Then based on the domain graph, a domain-rank is constructed which is an estimate of how much trust there is in that domain, as indicated at 304. At 306, the domain rank values and the number of documents contained in said domain are then used to assign a minimum rank to each server document. Thus, in order to inflate ranks of the document as a work-around, the author needs to invest money in both IP addresses and domains.

In mathematical terms, assume that the set of IP addresses that are used to host the documents being ranked is defined by A={a₁, a₂ . . . aₙ}, the set of domains is D={d₁, d₂ . . . dₘ}, and set of web-pages is W={w₁, w₂ . . . wₚ}. Let W(d)={w: w is hosted on domain d} be the set of pages hosted on domain d, A(d)={a: a is one of the IP addresses that hosts domain d}, D(a)={d: d is hosted on a}, and D(w) be the domain for web-page w.

Then, if randomly choosing an IP address and randomly choosing one of the domains hosted on that IP address, T(d) is the domain trust value or the probability that a domain d will be chosen.

$$T ( d ) = {\sum }_{a ∈ A ( d )} \frac{1}{\vert A \vert \vert D ( a ) \vert} .$$

Now, for any page w, O(w) is the set of pages to which w points, or the outgoing links of w.
O(w)={w′: w links to w′}.
Similarly, for any page w, I(w) is the set of pages that point to w, or the incoming links to w.
I(w)={w′: w′ links to w}

These two definitions are extended to domains as follows:
O(d)={d′:∃w,w′: w∈W(d)ˆw′∈W(d′)ˆw′∈O(w)}
I(d)={d′:∃w,w′: w∈W(d)ˆw′∈W(d′)ˆw′∈I(w)}

Based on this, for each domain d, the domain-rank value, R(d), of domain d can be computed by solving the following recurrence relationship.

$$R ( d ) = ɛ T ( d ) + ( 1 - ɛ ) {\sum }_{{d}^{′} ∈ I ( d )} \frac{R ( {d}^{′} )}{\vert O ( {d}^{′} ) \vert} .$$

Once these rank values are calculated, the document/page trust value T(w) of each page w can be defined as: or,

$$T ( w ) = \frac{R ( D ( w ) )}{\vert W ( D ( w ) ) \vert} .$$

Based on this, again solve the document/page rank value R(w) or recurrence relationship for ranks of individual pages.

$$R ( w ) = ɛ T ( w ) + ( 1 - ɛ ) {\sum }_{{w}^{′} ∈ I ( w )} \frac{R ( {w}^{′} )}{\vert O ( {w}^{′} ) \vert} .$$

Note that the provided equations are just one implementation. Other mathematical formulations or weighting schemes can be employed to achieve where the ranking of domains with respect to other domains, and then that ranking applies to the respective pages in each domain.

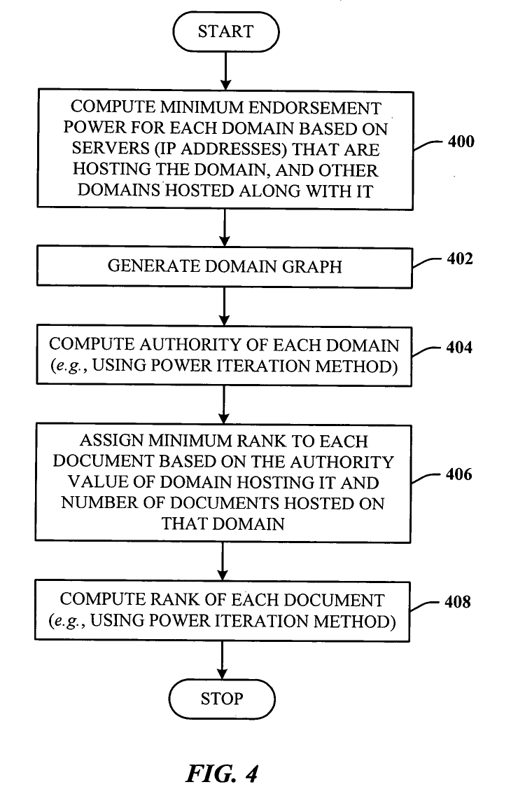

FIG. 4 illustrates a methodology of ranking data based on the number of servers used to host a domain in accordance with an aspect. At 400, compute a minimum endorsement power for each domain based on the server (IP addresses) that are hosting the domain, and the number of other domains hosted along with it. At 402, a domain graph is then generated. At 404, based on the domain graph, compute the authority (domain rank) of each domain using a power iteration method. A minimum rank (document trust value) is then assigned to each document based on the authority of the domain hosting it, and the number of documents hosted on that domain, as indicated at 406. At 408, a rank for each document is computed using the power iteration method.

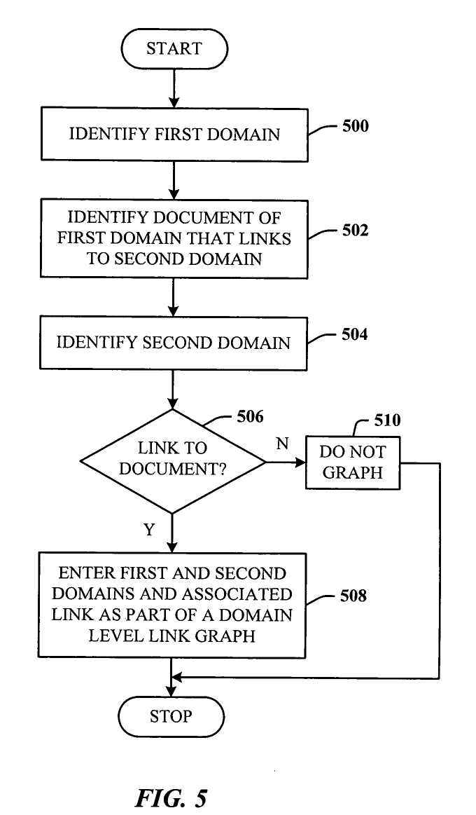

FIG. 5 illustrates a methodology of generating a domain-level link graph according to an aspect. At 500, a first domain (D1) is identified. At 502, a first document of the first domain is identified that includes a link to a second domain (D2). At 504, the second domain is identified. At 506, the system determines if there is a link from the first document to a second document in the second domain. If so, at 508, enter the first and second domains into the graph, and the associated link as part of the domain-level link graph. On the other hand, if at 506, there is not a link from the first document to the second document, flow is from 506 to 510 to not graph the D1-D2 relationship.

When building the domain-level link graph, the relationship of the first domain D1 to the second domain D2 is entered if and only if there is a document or web page hosted on the first domain D1 that links to another document or web page hosted on the second domain D2. For this graph, the ranks are computed using a method described in US patent publication 2005/0060297, and then the rank of each domain is divided by the number of documents in that domain to arrive at a value to assign a minimum rank to each document in that domain.

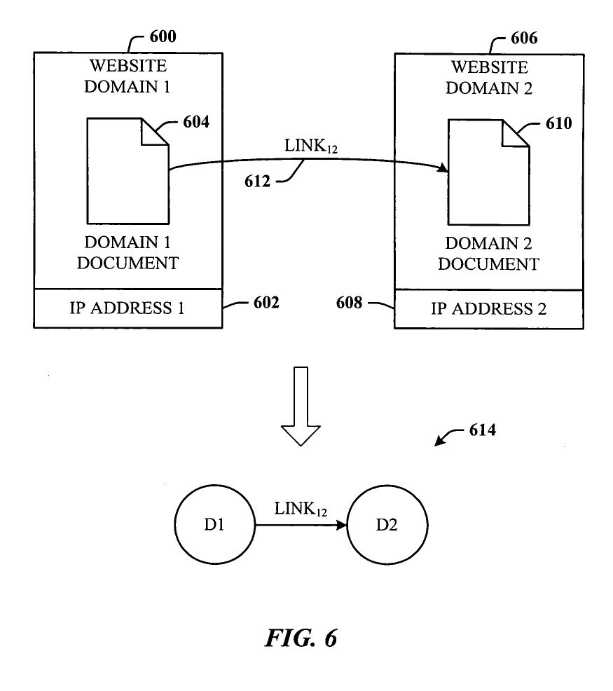

FIG. 6 illustrates a diagram that relates a unidirectional link between documents of two different domains in accordance with the disclosed innovation. A first domain 600 has associated therewith a first IP address 602 and a first document or web page 604. A second domain 606 has associated therewith a second IP address 608 and a second document or web page 610. The first document 604 includes a link 612 (denoted Link₁₂) (e.g., pointer, URL or hyperlink) that points to the second document 610. This link relationship is represented as a domain-level link graph 614.

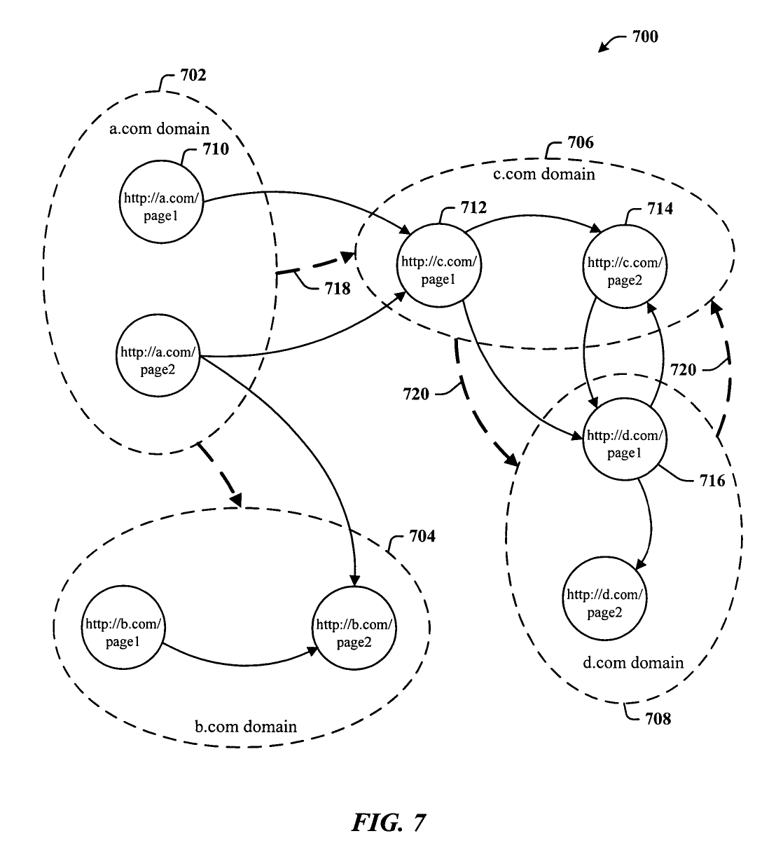

FIG. 7 illustrates a diagram 700 that represents domains, hyperlinks and implied domain links in accordance with the disclosed innovation. Four domains are shown: a first domain 702 (denoted a.com domain), a second domain 704 (denoted b.com domain), a third domain 706 (denoted c.com domain) and a fourth domain 708 (denoted d.com domain). Each domain includes two documents (for illustrative purposes only) that link to other documents. For example, the first domain 702 contains a first document 710 (denoted by the link http://a.com/page1) that links to a second document 712 in the third domain 706. The second document 712 can link to two other documents (or pages): a third document 714 in the third domain 706, and a fourth document 716 in the fourth domain 708. The third and fourth documents (714 and 716) have reciprocating links. Additionally, there can be inferred domain links between the domains (702, 704, 706 and 708). For example, there is an inferred link 718 from the first domain 702 to the third domain 706. Additionally, there are reciprocating inferred domain links 720 between the third domain 706 and the fourth domain 708.

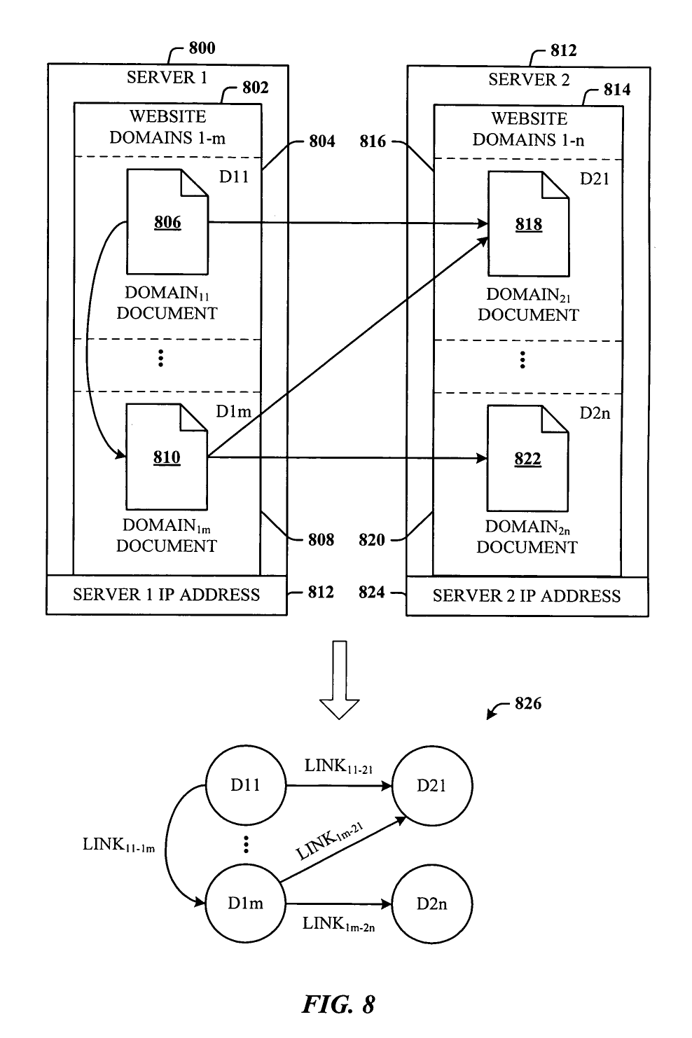

FIG. 8 illustrates a single server and multiple domain representation and associated document links between the different domains in accordance with the disclosed innovation. A first server 800 includes multiple domains 802, denoted DOMAINS 1-m. A first domain 804 (denoted D11) has associated therewith a first document 806, and an m^{th} domain 808 (denoted D1m) has associated therewith a second document 810. The first server 800 also has an assigned IP address 812. A second server 812 includes multiple domains 814, denoted DOMAINS 1-n. A third domain 816 (denoted D21) has associated therewith a third document 818, and nth domain 820 (denoted D2n) has associated therewith a fourth document 822. The second server 812 also has an assigned IP address 824. In this example, the first document 808 links to the second document 810 and the third document 818. The second document 810 links to the third document 818 and the fourth document 822. A domain-level link graph 826 illustrates the link relationships.

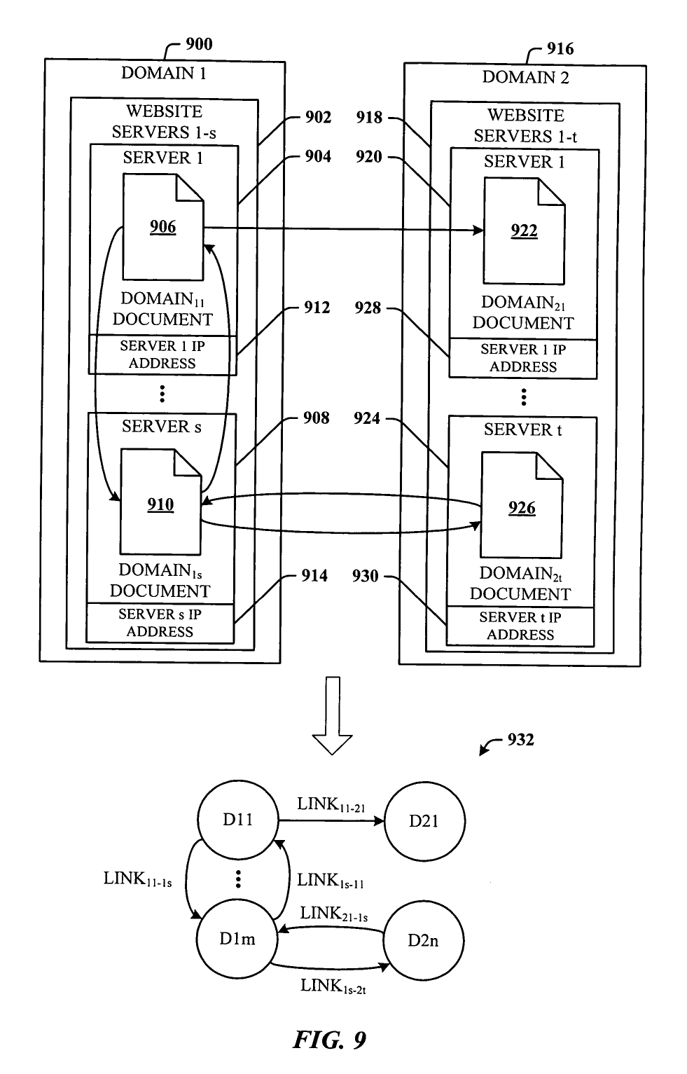

FIG. 9 illustrates a single domain and multiple servers of that domain and associated document links in accordance with the disclosed innovation. A first domain 900 includes multiple servers 902, denoted SERVERS 1-s. A first server 904 (denoted SERVER 1) has associated therewith a first document 906, and an s^{th} server 908 (denoted SERVER s) has associated therewith a second document 910. The first server 904 also has an assigned IP address 912 and the s^{th} server an assigned IP address 914. Similarly, a second domain 916 includes multiple servers 918, denoted SERVERS 1-t. A third server 920 (denoted SERVER 1) has associated therewith a third document 922, and a t^{th} server 924 (denoted SERVER t) has associated therewith a fourth document 926. The third server 920 also has an assigned IP address 928 and the t^{th} server, an assigned IP address 930.

In this example, the first document 906 links to the second document 910 and the third document 922. The second document 910 links back to the first document 906 and the fourth document 926. The fourth document 926 links back to the second document 910. A domain-level link graph 932 illustrates the link relationships.

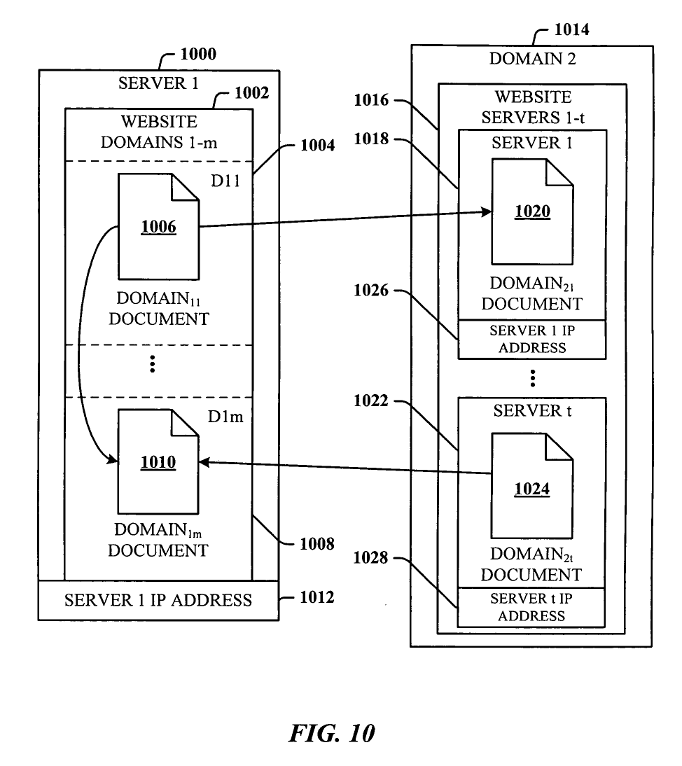

FIG. 10 illustrates documents of a single server/multiple domains linking with documents of a single domain/multiple servers in accordance with the disclosed innovation. A first server 1000 includes multiple domains 1002, denoted DOMAINS 1-m. A first domain 1004 (denoted D11) has associated therewith a first document 1006, and an m^{th} domain 1008 (denoted D1m) has associated therewith a second document 1010. The first server 1000 also has an assigned IP address 1012.

Another domain 1014 (denoted DOMAIN 2) includes multiple servers 1016, denoted SERVERS 1-t. A second server 1018 (denoted SERVER 1 of DOMAIN 2) has associated therewith a third document 1020, and a t^{th} (or third) server 1022 (denoted SERVER t) has associated therewith a fourth document 1024. The second server 1018 has an assigned IP address 1026 and the third (or t^{th}) server 1022 also has an assigned IP address 1028. In this example, the first document 1006 links to the third document 1020, and the second document 1010. The second document links to the fourth document 1024.

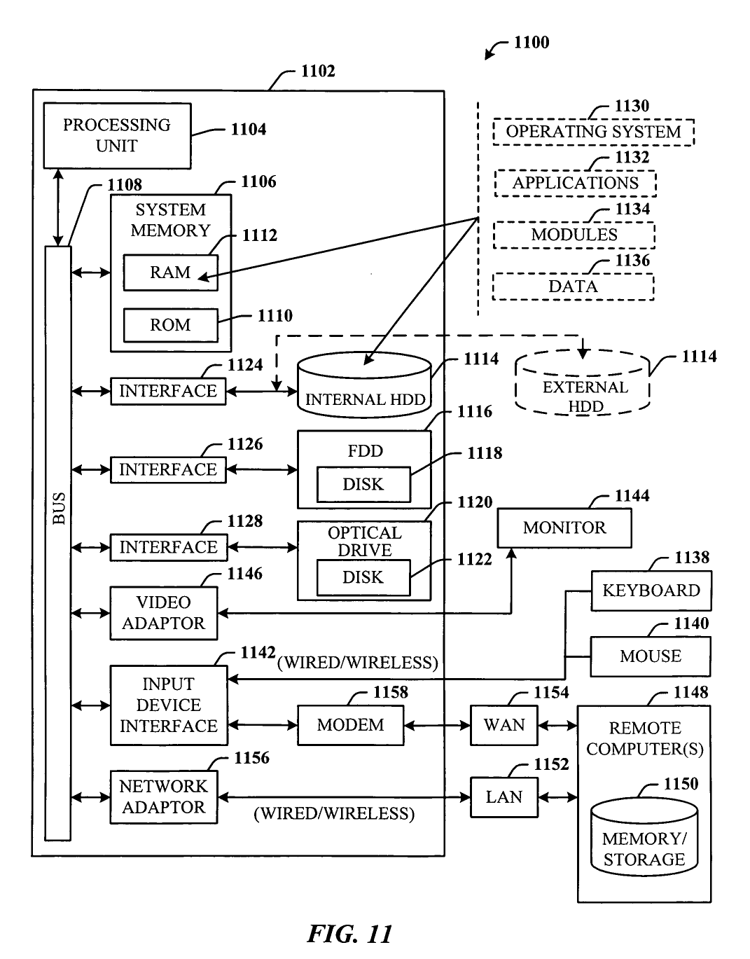

Referring now to FIG. 11, there is illustrated a block diagram of a computer operable to execute the disclosed architecture. In order to provide additional context for various aspects thereof, FIG. 11 and the following discussion are intended to provide a brief, general description of a suitable computing environment 1100 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the innovation can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1394 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

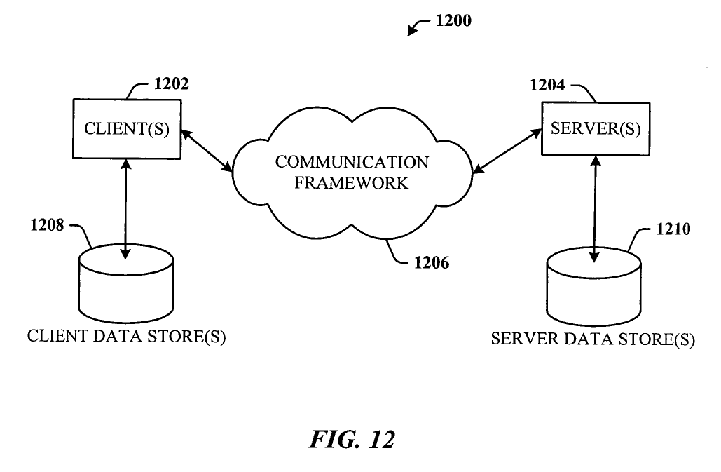

Referring now to FIG. 12, there is illustrated a schematic block diagram of an exemplary computing environment 1200 in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the subject innovation, for example.

The system 1200 also includes one or more server(s) 1204. The server(s) 1204 can also be hardware and/or software (e.g., threads, processes, computing devices). The servers 1204 can house threads to perform transformations by employing the invention, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed innovation. It is, of course, not possible to describe every conceivable combination of components and/or methodologies, but one of ordinary skill in the art may recognize that many further combinations and permutations are possible. For example, generalizing to a higher level, a document can include an internal structure rather than objects that are being searched. Thus, searching is not for a flat list of objects, but through an object hierarchy. The subject innovation can then be applied into one of the hierarchy levels and ranking each level or subdivision.

The innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates data ranking, comprising the following computer-executable components:
a trust component that computes a domain trust value for a domain having a document and a document trust value; and
a rank component that computes a domain rank value for the domain based on the domain trust value and domain rank values of other domains, and a document rank value that depends on the document trust value and document rank values of other documents.

2. The system of claim 1, wherein the document trust value computed by the trust component depends on the domain rank value of the domain having the document.

3. The system of claim 1, wherein the domain trust value is based on a plurality of network servers on which the domain is hosted.

4. The system of claim 1, wherein the document trust value is based on a plurality of domains hosted on a network server.

5. The system of claim 1, wherein the document is a web page.

6. The system of claim 1, wherein the rank component computes the domain rank value based also upon a set of other domains that link to the domain.

7. The system of claim 1, wherein the rank component computes the rank of the document based on a trust value for each document and a page that links to the document.

8. The system of claim 1, wherein the rank component computes the rank of the document based on a trust value for each document and all pages that link to the document.

9. The system of claim 1, wherein the rank component facilitates presentation of the document according to the rank.

10. The system of claim 1, wherein the domain trust value is computed based on a number of domains served by each web server that serves the domain.

11. A computer-implemented method of ranking data, the method comprising the following computer-executable acts:
computing a domain trust value of a domain base on a set of servers on which the domain is hosted;
computing a domain rank value based on the domain trust value and domain rank values of other domains that link to the domain;
computing a document trust value based on the domain rank value of the domain and set of documents contained in the domain; and
computing a document rank value for each document of the set.

12. The method of claim 11, wherein the act of computing the document rank value is further based on document rank values for other documents that link to the document.

13. The method of claim 11, further comprising an act of dividing the domain rank value of the domain by a total number of documents in that domain.

14. The method of claim 11, further comprising an act of associating the domain trust value with an IP address.

15. The method of claim 11, further comprising an act of assigning the document rank value to each document, which document rank value is a minimum rank value.

16. The method of claim 11, further comprising an act of adding a link relationship to a domain-level link graph only when a document of a first domain links to a document of a second domain.

17. The method of claim 11, further comprising an act of generating a domain rank based on a domain-level link graph.

18. The method of claim 11, wherein the act of computing a domain rank value is based upon the domain trust value and a set of other domains that link to the domain.

19. A computer-executable system, comprising:
computer-implemented means for computing a domain trust value for a domain having documents, the domain associated with an IP address;
computer-implemented means for constructing a domain-level link graph that represents relationships associated with the documents; and
computer-implemented means for computing a document rank value of the domain based on the domain trust value.

20. The system of claim 19, further comprising computer-implemented means for computing ranks of the documents based upon the domain trust value of the domain and which other documents link to the documents.
